(19) United States
(12) Patent Application Publication
(10) Pub. No.: US 2026/0332552 A1
(43) Pub. Date: Oct. 22, 2026

(54) A METHOD AND SYSTEM FOR SECURE COMMUNICATION

(71) Applicant: Arqit Limited, London (GB)

(72) Inventors: David Webb, Sussex (GB); Shaun George, Cardiff (GB)

(21) Appl. No.: 19/108,585

(22) PCT Filed: Aug. 22, 2023
(86) PCT No.: PCT/GB2023/052184

§ 371 Date: Mar. 4, 2025

(30) Foreign Application Priority Data
Sep. 6, 2022 (GB) 2213017.3

(51) Int. Cl. H04L 61/2521; H04L 9/40; H04L 61/58; H04L 69/164

(52) U.S. Cl. CPC H04L 61/2528; H04L 61/58; H04L 63/0281; H04L 63/0435; H04L 69/164

(57) ABSTRACT

A method for secure communication between a client endpoint and an application cloud across a network, the method includes negotiating symmetric keys between client and cloud proxies, capturing data packets from a client application, encrypting packets using the symmetric key, forwarding encrypted packets to the cloud proxy, decrypting by the cloud proxy the data packets, and modifying by the cloud proxy the data packets by replacing an IP address associated with the client endpoint and a port number associated with the client application with its own, and forwarding the decrypted data packets to the server application, wherein the server application corresponds to a destination IP address specified in the data packet, and wherein the server application is located within the same security perimeter as the cloud proxy.

### FIELD OF THE INVENTION

The present application relates to a method and system for secure communication between a client endpoint and an application cloud across a communications network. In particular, the present invention comprises two paired proxies that provide a secure tunnel for communication between a client application and server application.

### BACKGROUND TO THE INVENTION

Many organisations rely on Microsoft's Office 365 for the running of their business. Users at these organisations routinely store sensitive documents in OneDrive and Sharepoint, send sensitive emails using Office 365 email, and collaborate on Word, Excel and Powerpoint documents with their colleagues.

All Microsoft software uses Transport Layer Security (TLS) to provide encryption of data between endpoints (e.g. laptops) and the Microsoft cloud. Similarly, software from many other sources uses TLS to provide encryption of data between endpoints and a cryptographically protected nexus such as a cloud. TLS will be vulnerable to record-now attack-later type attacks once quantum computers are large enough to run Shor's algorithm. Thus, data that is being recorded today is expected to be vulnerable to such attacks. As such, all corporate data flowing over the communications network to and from Microsoft services or similar services is subject to this attack.

The inventors have devised the claimed invention in light of the above considerations.

The embodiments described below are not limited to implementations which solve any or all of the disadvantages of the known approaches described above.

### SUMMARY OF INVENTION

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

In a first aspect, the present disclosure provides a method for communication between a client endpoint and an application cloud across a communications network, the method comprising: i) negotiating, between a client proxy and a cloud proxy, one or more common symmetric keys using a symmetric key agreement system, wherein the client proxy is located within the client endpoint, and the cloud proxy is located within a security perimeter of the application cloud; ii) capturing, by the client proxy, a data packet from a client application, wherein an IP address, subnet or domain to which the data packet is being sent is defined in a security policy, and wherein the client application is located within the same client endpoint as the client proxy; iii) encrypting, by the client proxy, the captured data packet using a common symmetric key, to form an encrypted data packet; iv) forwarding, by the client proxy, the encrypted data packet to the cloud proxy, wherein the security policy specifies the IP address of the cloud proxy to which the data packet is to be forwarded; v) decrypting, by the cloud proxy, the encrypted data packet using the common symmetric key to obtain the captured data packet; vi) modifying, by the cloud proxy, the data packet by replacing an IP address associated with the client endpoint and a port number associated with the client application with an IP address and a port number associated with the cloud proxy; and vii) forwarding, by the cloud proxy, the decrypted data packet to the server application, wherein the server application corresponds to a destination IP address specified in the data packet, and wherein the server application is located within the same security perimeter as the cloud proxy.

Preferably, operations ii) to vii) are repeated for each data packet captured by the client proxy.

Preferably, the method further comprises obtaining, by a client proxy, the security policy from the symmetric key agreement system prior to capturing the data packet by the client proxy.

Preferably, the obtaining the security policy comprises requesting, by the client proxy, the security policy from the symmetric key agreement system, and in the event that client proxy is not successful in receiving the security policy, the client proxy sends a further request after a set amount of time to the symmetric key agreement system to obtain the security policy.

Preferably, the security policy further specifies one or more cloud proxy IP addresses corresponding to one or more cloud proxies to be routed through the security policy, wherein each cloud proxy is located in a different application cloud.

Preferably, the client proxy encapsulates each encrypted data packet with a user datagram protocol (UDP) header prior to transmitting each data packet to the cloud proxy.

Preferably, the client proxy sets a maximum transmission unit of a network interface prior to encapsulation, wherein the client endpoint comprises the network interface, and wherein the network interface is configured to route data packets in and out of the client endpoint.

Preferably, after the decrypting, the cloud proxy caches the IP address and the port number associated with the client application for each data packet received from the client proxy.

Preferably, the cloud proxy removes the UDP header from each data packet prior to caching the IP address associated with the client endpoint and the port number associated with the client application.

Preferably, the cloud proxy modifies each decrypted data packet by replacing the IP address of the client endpoint with a corresponding cloud proxy IP address, and wherein the cloud proxy further maps the port number associated with the client application to an empty port associated with the cloud proxy, prior to transmitting each data packet to the server application.

Preferably, the client endpoint is a web gateway.

Preferably, the client application is a web gateway application.

Preferably, the symmetric key agreement system is a symmetric key cloud.

Preferably, the communications network is the Internet.

Preferably, apart than being encrypted and modification of the IP address and port number of the data packets when being forwarded between the client proxy and the cloud proxy, the data packet is otherwise unmodified by the client proxy and the cloud proxy, such that Transport Layer Security, TLS, connections remain unbroken.

Preferably, if cloud proxy is not available, the data packet is not forwarded to the cloud proxy, and the client application will register this as a Transmission Control Protocol (TCP) packet drop.

In a second aspect, there is provided a method for communication between a client endpoint and an application cloud across a communications network, the method comprising: i) forwarding, by the server application, the response packet to the cloud proxy, wherein the forwarding of the response packet by the server application is in response to a data packet sent by the cloud proxy; ii) modifying, by the cloud proxy, the response packet by replacing an IP address and port number associated with the cloud proxy with an IP address associated with the client endpoint and port number associated with a client application, wherein the client application is located within the client endpoint; iii) encrypting, by the cloud proxy, the response packet using a common symmetric key, to form an encrypted response packet, wherein the common symmetric key has been negotiated between a client proxy and the cloud proxy; iv) forwarding, by the cloud proxy, the encrypted response packet to the client proxy, wherein the client proxy is located within the client endpoint, and wherein the client application is located within the same client endpoint as the client proxy; v) decrypting, by the client proxy, the encrypted response packet using said common symmetric key; and vii) forwarding, by the client proxy, the decrypted response packet to the client application.

Preferably, operations i) to vii) are repeated for each response packet forwarded by the server application.

Preferably, the cloud proxy encapsulates each encrypted response packet with a user datagram protocol header prior to transmitting the encrypted response packet to the client proxy.

Preferably, the client proxy removes the user datagram protocol header from the response packet prior to decrypting of the response packet.

Preferably, the communications network is the internet.

Preferably, apart than being encrypted when being forwarded between the client proxy and the cloud proxy, the response packet is otherwise unmodified by the client proxy and the cloud proxy, such that Transport Layer Security, TLS, connections remain unbroken.

In a third aspect, the present disclosure provides a method of communication by a client endpoint with an application cloud across a communications network, the method comprising: i) negotiating, by a client proxy with a cloud proxy, one or more common symmetric keys using a symmetric key agreement system, wherein the client proxy is located within the client endpoint, and the cloud proxy is located within the application cloud; ii) capturing, by the client proxy, a data packet from a client application, wherein an IP address, subnet or domain to which the data packet is being sent is defined in a security policy, and wherein the client application is located within the same client endpoint as the client proxy; iii) encrypting, by the client proxy, the captured data packet using a common symmetric key, to form an encrypted data packet; and iv) forwarding, by the client proxy, the encrypted data packet to the cloud proxy, wherein the security policy specifies the IP address of the cloud proxy to which the data packet is to be forwarded, whereby the cloud proxy is able to decrypt the encrypted data packet using the common symmetric key.

In a fourth aspect, the present disclosure provides a method of communication by an application cloud with a client endpoint across a communications network, the method comprising: i) forwarding, by the server application, the response packet to the cloud proxy, wherein the forwarding of the response packet by the server application is in response to a data packet sent by the cloud proxy; ii) modifying, by the cloud proxy, the response packet by replacing an IP address and port number associated with the cloud proxy with an IP address associated with the client endpoint and port number of a client application, wherein the client application is located within the client endpoint; iii) encrypting, by the cloud proxy, the response packet using a common symmetric key, to form an encrypted response packet, wherein the common symmetric key has been negotiated between a client proxy and the cloud proxy; and iv) forwarding, by the cloud proxy, the encrypted response packet to the client proxy, wherein the client proxy is located within the client endpoint, and wherein the client application is located within the same client endpoint as the client proxy, and whereby the client proxy is able to decrypt the encrypted data packet using the common symmetric key.

In a fifth aspect, the present disclosure provides a computer program comprising instructions which, when the program is executed by a processor, cause the processor to carry out the method of any of the third or the fourth aspects.

In a sixth aspect, the present disclosure provides a computer-readable medium comprising instructions which, when executed by a processor cause the processor to carry out the method of any of the third or the fourth aspects.

In a seventh aspect, the resent disclosure provides a system for communication between a client endpoint and an application cloud across public internet, the system comprising: a symmetric key agreement system for providing one or more symmetric keys; a client endpoint, wherein the client endpoint comprises: one or more client applications; and a client proxy configured to communicate with the one or more client applications; and an application cloud, wherein the application cloud comprises: one or more server applications; and a cloud proxy configured to communicate with one or more server applications, wherein the system is configured to perform the methods disclosed herein.

Preferably, the system further comprises a network interface configured to route data in or out of the client endpoint.

Preferably, a separate symmetric key is used for communication between the endpoint and the cloud proxy within the application cloud.

Preferably, the same symmetric key is used for communication between the client endpoint and two or more server applications within the application cloud.

Preferably, the application cloud is a single tenant cloud.

Preferably, the application cloud is a multi-tenant cloud.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is issued for designing silicon chips, or for configuring universal programmable chips, to carry out desired functions.

The features and embodiments discussed above may be combined as appropriate, as would be apparent to a person skilled in the art, and may be combined with any of the aspects of the invention except where it is expressly provided that such a combination is not possible or the person skilled in the art would understand that such a combination is self-evidently not possible.

### BRIEF DESCRIPTION OF THE DRAWINGS

Embodiments of the present invention are described below, by way of example, with reference to the following drawings.

FIG. 1 shows a schematic of the system for communication between a client endpoint and an application cloud;

FIG. 2a shows a schematic of the processes that occur during client-server communication;

FIG. 2b shows a schematic of the processes that occur during server-client communication;

FIG. 3a is a flowchart of the processes that occur during client-server communication;

FIG. 3b is a flowchart of the processes that occur during server-client communication; and

FIG. 4 shows the processes that occur during when one or more software of the system of FIG. 1 in a downed state during communication between client endpoint and an client endpoint.

Common reference numerals are used throughout the figures to indicate the same or similar features.

### DETAILED DESCRIPTION

Embodiments of the present invention are described below by way of example only. These examples represent the best mode of putting the invention into practice that are currently known to the Applicant although they are not the only ways in which this could be achieved. the description sets forth the functions of the example and the sequence of steps for constructing and operating the example. However, the same or equivalent functions and sequences may be accomplished by different examples.

This innovation provides a pair of proxies, one on the endpoint and one in the cloud, through which all TLS traffic related to specific applications protected by the proxies is passed. Traffic related to other applications does not pass through the proxy, and may be routed in any convenient manner. A proxy is a service that acts as an intermediary between a client requesting a resource and the server providing that resource. The proxies encrypt and decrypt at the packet level using keys agreed between the endpoint proxy and the cloud proxy using cloud-based symmetric key agreement.

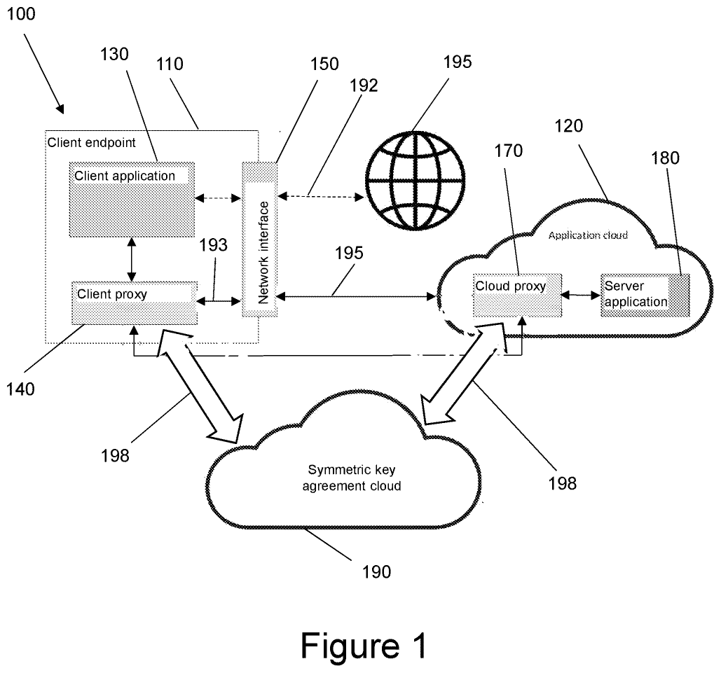

FIG. 1 shows a system 100 for exchanging data packets between a client endpoint 110 and an application cloud 120 over a communications network 195. In the illustrated embodiment, the communications network 195 is the public Internet, but this is not essential, and other communications networks may be used. The client endpoint 110 may be a user device, for example, a PC, a laptop, a mobile phone, or the like. This list of examples is not intended to be exhaustive. In some examples the application cloud 120 may be an enterprise security boundary. Examples of application clouds 120 include a Microsoft cloud, a Google Cloud Platform, an Atlassian datacentre/region, or a Salesforce datacentre/region. This list of examples is not intended to be exhaustive. In one example, the application cloud 120 may be an enterprise on-prem service, such as an on-prem file collaboration service which is accessible from outside the corporate security perimeter. The endpoint 110 has located/installed in it one or more client applications 130. The client proxy 140 is configured to capture data packets from any application situated with the client endpoint 110. In the illustrated example, this is achieved by the client proxy 140 inserting its driver (not shown) into an operating system of the client endpoint 100 such that the driver can capture data packets from relevant applications without them knowing (including from the client application 130), and then forward the data packets onto the cloud proxy 170 (if it is traffic to a specified SaaS application such as the server application 180) or to their original destination (if it is not traffic to a specified SaaS application). In alternative examples the client proxy 140 may achieve this in a different manner. The endpoint 110 further comprises a network interface 150 configured to route data packets in and out of the endpoint 110. In some examples, the client endpoint 140 may comprise more than one network interface 150. The application cloud 120 has deployed to it cloud an installable proxy software 170 and one or more server applications 180. Examples of server applications 180 include OneDrive, Azure for Microsoft applications, GoogleDrive, JIRA, and Salesforce. This list of examples is not intended to be exhaustive.

In some embodiments, the client endpoint 110 is a web gateway, and the client application 130 is a web gateway application. If the web gateway is located on the boundary of the enterprise and intercepts all traffic flowing out, then by installing the client proxy 140 onboard the web gateway 110, the client proxy 140 can capture outgoing traffic from the web gateway application 130, allowing the web gateway to perform its traffic inspection and rule execution before the client proxy 140 handles the over-the-internet security from the web gateway 110 to the application cloud 120.

In the illustrated example of FIG. 1, the cloud proxy 170 and the server application 180 are situated within a security perimeter of the same application cloud 120. This perimeter protects the connection between the cloud proxy 170 and the SaaS from the active and critical threat commonly called Store Now, Decrypt Later (SNDL) attack by third parties, allowing TLS to be safely used between them. SNDL is a practice where third parties intercept sensitive data moving across the network and hold onto it with the intent of decrypting it once quantum computing becomes available in the future. For example, both the cloud proxy 170 and the one or more server applications 180 may be deployed within Microsoft Azure for Microsoft Office 365, within Google Cloud Platform for GoogleDrive, within an Atlassian datacentre for JIRA, or within a Salesforce datacentre for Salesforce. By placing the cloud proxy 170 within such a perimeter, the cloud proxy 170 and its link to the server application 180 is protected from becoming a target. Although FIG. 1 shows only a single cloud proxy 170, the client proxy 140 may be connected to multiple cloud proxies 170, where each cloud proxy 170 is located in a different application cloud 120. In addition, in order to achieve horizontal scalability, in some examples, there may be many cloud proxy instances within the same perimeter sitting behind a load balancer (not shown). In another words, the cloud proxy 170 may be a single application running on a single IP address, or a collection of cloud proxies 140 sitting behind a load balancer. The latter allows the solution to scale out without limit by adding more instances of the cloud proxy. In some embodiments, the cloud proxy 170 is deployed into a customer's own cloud tenant (e.g. to their Azure tenant for Microsoft Corporation (MSFT), Google Cloud computing (GCP) for any google apps etc.), and dedicated to the customer's traffic. However, it is not essential that the cloud proxy 170 and the server application 180 are situated within a security perimeter of the same application cloud 120 as long as the connection between them is secured by a quantum safe tunnel, and this may not be the case in some examples.

In some other embodiments, the cloud proxy 170 is deployed into a third-party tenant, such as the Arqit tenant, as a multi-tenant proxy and used for traffic across many customers. For example, a customer may use a SaaS version of this invention. All customer traffic would route through the Arqit-hosted cloud proxies, alongside traffic from other Arqit customers. This avoids the customer hosting their own cloud proxies.

Moreover, both the client proxy 140 and the cloud proxy 170 are in communication with a symmetric key agreement system 190 via quantum resistant encryption protected channels 198, which are used to agree a common symmetric key (a bilocation key) to both of the client proxy 140 and the cloud proxy 170. In one embodiment, the symmetric key agreement system 190 is a symmetric key agreement cloud 190. Note that the common symmetric key is common between the client proxy 140 and the cloud proxy 170, and not a common key across all endpoints. Note that in FIG. 1, the solid double arrow 193 indicates data packets that are captured by the client proxy 140 as being destined for the server application 180. The captured packets are routed to the cloud proxy 170 via the network interface 150 and are encrypted by the bilocation key. The dotted double arrow 192 indicates all other packets that are not captured or encrypted by the bilocation key because they are not destined for the server application 180. The uncaptured packets are routed through the communications network 195, for example the public internet, unprotected via the network interface 150.

Note that the above system 100 is similar to a split-tunnel VPN, but different in that the system 100 uses a cloud service (symmetric key agreement cloud 190) to assist with symmetric key agreement between the proxies 140 and 170, and dedicated to specific IP subnets/domains related to the cloud service. Additionally, in the system 100 the cloud proxy 140 is installed inside the cloud provider's security perimeter (i.e. application cloud 120) to talk to cloud provider applications. Additionally, the system 100 can have different tunnels for different services.

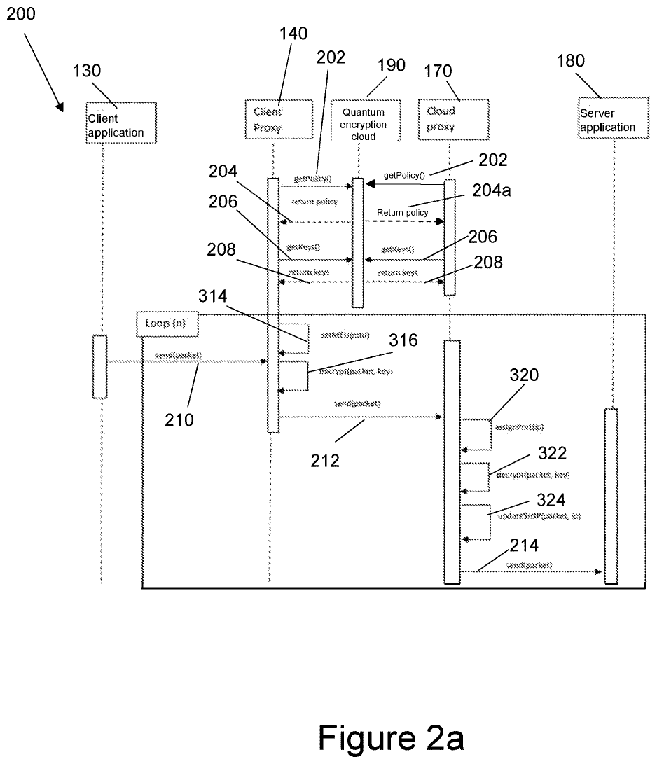

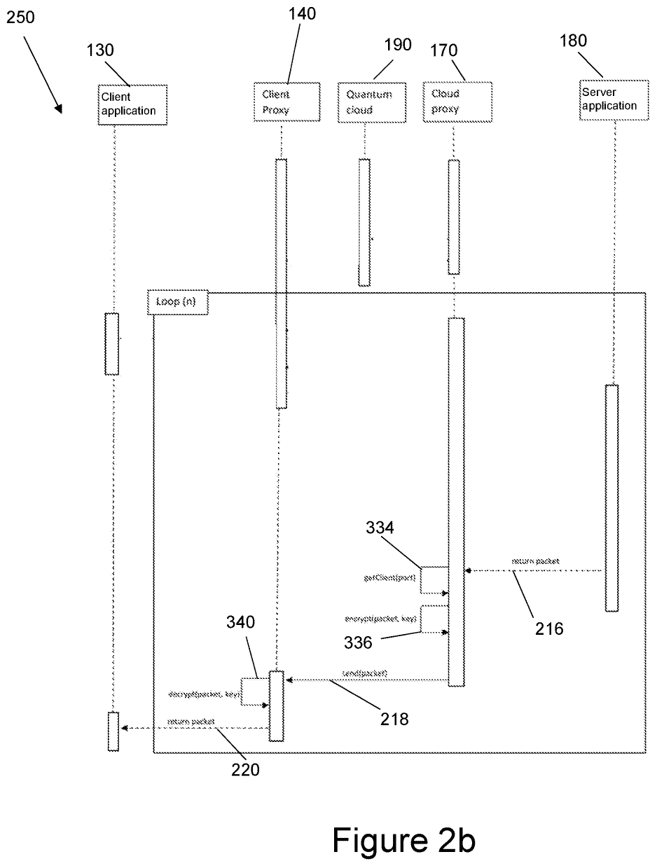

FIG. 2a shows a schematic 200 of the processes involved in the communication between a client endpoint 110 and a server application 180 (i.e., client-server communication).

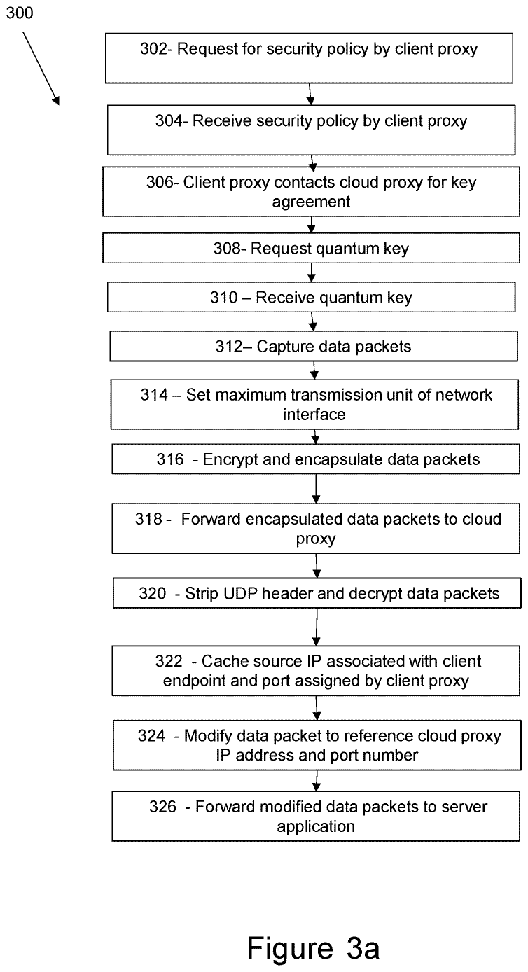

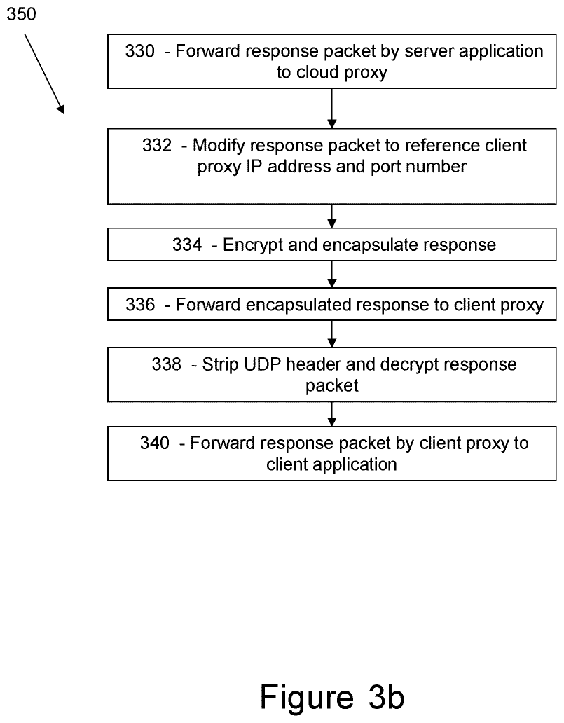

Further, a corresponding method 300 used to carry out the communication between the client endpoint 110 and the server application 180 is shown as a flowchart in FIG. 3a.

Referring to FIGS. 2a and 3a, also to FIG. 1, to begin the client-server communication, for example on start-up of the client proxy 140, at operation 302 the client proxy 140 makes a request 202 to obtain a security policy from the symmetric key agreement cloud 190. In response to the request 202, at operation 304, the symmetric key agreement cloud 190 prepares a security policy 204 and sends this to the client proxy 140, which receives the security policy 204 from symmetric key agreement cloud 190. The security policy 204 defines a list of destination IP addresses/subnets or domains for which the client proxy 140 is to capture outgoing data packets. The security policy also contains a list of cloud proxy addresses to which the client proxy 140 is to send the captured data packets for the respective destination IP addresses. Each cloud proxy 170 is located in a different application cloud 120. As also mentioned before, each cloud proxy 170 may be a single application running on a single IP address, or a collection of cloud proxy applications sitting behind a load balancer (or in another words, the cloud proxy 170 in FIG. 1 may be a collection of cloud proxy applications behind a load balancer or ingress gateway). The list of cloud proxy addresses associated with respective destination IP addresses enables the client proxy 140 to route intercepted data packets onwards to the appropriate cloud proxy 170 located within the application cloud 120. Accordingly, the subsequent routing (or transmission), by the cloud proxy 170, of the data packets to specific server applications 180 is based on an original IP address of each data packet (and is not separately defined by the security policy).

It should also be noted that there will be a list or range of IP addresses/subnets or domains for each cloud proxy 170 situated within the application cloud 120, where each IP address/subnet in the list or range corresponds to a different server application 180 within the application cloud 120. In the same operation 302, the cloud proxy 170 also makes a request 202 to obtain a security policy from the symmetric key agreement cloud 190. In response to the request 202, at operation 304, the symmetric key agreement cloud 190 prepares a security policy 204a and sends this to the cloud proxy 170, which receives the security policy 204 from the symmetric key agreement cloud 190. In this case, the security policy obtained after the request 202 is a more general security policy such as “enable/disable service etc. . . .

Note that the cloud proxies 120 and 170 are both transparent. A transparent proxy, also known as an inline proxy, intercepting proxy or forced proxy, is a server that intercepts the connection between an end-user or device and the internet. The proxies 140 and 170 are called “transparent” because they do so without modifying requests and responses. It should be noted that encryption of data packets (see below) is purely additive at the client endpoint 110 and removed at the application cloud 120 (and vice versa). Additionally, the data packet IP address and port number is also modified during communication (see later). Apart from these modifications, the data packets are unmodified outside of the link 195 between client 140 and cloud 170 proxies, such that TLS connections are unbroken.

The client proxy 140 and the cloud proxy 170 then both negotiate one or more common symmetric keys, which will be used to encrypt and/or decrypt messages sent between the endpoint 110 and the application cloud 120. To do this, in an operation 306, the client proxy 140 contacts the cloud proxy 170 to inform the cloud proxy that a key needs to be agreed. At operation 308 client proxy 140 and the cloud proxy 170 both send respective requests 206 for a key to the symmetric key agreement cloud 190. In one embodiment, different symmetric keys are used for communication between different server applications 180. For example, the security policy 204 may group OneDrive and Sharepoint together to share a bilocation key, but Teams and Outlook each have their own bilocation key. The client proxy 140 and the cloud proxy 170 also agree one or more Key ID's, where each key ID is associated with an agreed separate common symmetric key, such that the proxies 140 and 170 can later use the Key ID to locate the appropriate symmetric key for use. The security policy 204 does not specify which bilocation key to use, but instead instructs the client proxy 140 to agree multiple keys with different cloud proxies 170 and route through different tunnels for different traffic. This allows for the creation of a dedicated cryptographic tunnel for each of the one or more server applications 180 located within an application cloud, which improves security of the communication system 100 as a whole. At operation 310, both the client proxy 140 and cloud proxy 170 agree and receive a common symmetric key 208 using the symmetric key agreement cloud 190.

At operation 312, the client proxy 140 starts capturing outgoing data packets 210 sent from the client application 130 that are destined for IP addresses, as defined in the security policy 204. At this stage, the data packet comprises the IP address of the client endpoint 110, and a port number associated with client application 130 from which the data packet originated. The data packet also comprises a destination IP address and port number of the server application 180 to which the data packet is to be forwarded.

In the event that the client proxy 140 is not available when the client application 130 sends a data packet 210 at operation 310, the data packets 210 will not be intercepted by the client proxy 140 and will be routed directly to their destination (server application 180) and not via the cloud proxy 170. Additionally, if the cloud proxy 170 is not available, then the data packet (once captured by the client proxy 140) will not be sent to the cloud proxy 170, otherwise an attacker could break the protection by blocking the transmission of data packets to the cloud proxy 170. In some examples, the client application may be arranged to not send data packets 210 if the client proxy 140 is not available, in order to prevent any loss of security.

At operation 314, the client proxy 140 sets the maximum transmission unit (MTU) of the network interface 150 in order to allocate some space of encrypted packet encapsulation (see subsequent operations). In some examples, the MTU is set to 1400. The MTU is the size of the largest protocol data unit (PDU) that can be communicated in a single network layer transaction. In one example, the MTU is set to 1400, which is recommended by Microsoft in order to allow some space to be allocated for the encrypted packet encapsulation, as described below.

At operation 316, the client proxy 140 encrypts the captured data packets 210 using the common symmetric key 208 agreed by the symmetric key agreement cloud 190. Additionally, in the same operation, the client proxy 140 encapsulates the encrypted data packets in a user datagram protocol (UDP) packet. Additionally, the client proxy 140 also assigns a port number to the data packet and saves the IP address and port number of the client application 130 from which the data packet originated from, such that the client proxy 140 is able to deliver a return data packet back to the original client application 130. In some examples, the port number assigned by the client proxy 140 is the same port number used by the client application 130. This means that the UDP data packet, after being created by the client proxy 140, now comprises the IP address of the client endpoint, the destination IP address, the source port number associated with the client proxy 140 and the destination port associated with the cloud proxy 170. Note that the UDP data packet has no knowledge of the port numbers of the client 130 and the server application 180, as these port numbers are hidden from the client 140 and cloud 170 proxies (the UDP data packet only has knowledge of the port numbers client 140 and cloud 170 proxies).

At operation 318, the client proxy 140 forwards the encapsulated UDP data packet 212 to the appropriate cloud proxy 170, wherein the cloud proxy 170 is identified by the cloud proxy address defined by the security policy 204 as corresponding to the destination IP address of the captured outgoing data packets 210. In the present application, it is assumed that once a packet is within the application cloud 120 (e.g. Microsoft cloud), it is deemed safe from SNDL attacks. Additionally, it is also assumed that once inside the application cloud 120, the packet will not route unprotected across the public internet 195 (i.e. if it were to route over the public internet it would be through a secured communications network 191 within the application cloud security perimeter, as shown in FIG. 1). The use of UDP for the encapsulated data packets is not essential, and other examples may use different encapsulation protocols.

Once the appropriate cloud proxy 170 receives the encapsulated UDP data packet 212 from the client proxy 140, at operation 320, the cloud proxy 170 removes the UDP header from the received encapsulated UDP data packets 212. In the same operation, the cloud proxy 170 uses the key ID associated with the client proxy 140 to locate the appropriate symmetric key 208 negotiated earlier (in operations 306 to 310) and use this symmetric key 208 to decrypt the data packets 212 to obtain the original data packets. At operation 322, the cloud proxy 170 caches the client endpoint IP address and port number associated with the client application 130. More specifically, the cloud proxy 170 maintains a list of outgoing port numbers that are in use or free. The cloud proxy 170 finds an unused outgoing port number and allocates this to the specific client endpoint IP and the port associated with the client application 130 to allow routing of the response back to the appropriate client endpoint 110. For example, the cloud proxy 170 looks for an unmapped port 99, and maps A:88 (where A is the client endpoint IP address and 88 is the port number of the client application 130) to the unmapped port 99 (port mapping), and sends the data packet to the server application 180 with the source address being modified to B:99. In this manner, when a response packet comes back from the server application 180 (see below), it will come back to source address B:99. The cloud proxy 170 will then look up the port in the cache, which resolves to A:88 (due to the mapping of A:88 to B:99), such that the cloud proxy 170 can send the response back to address A:88.

At operation 326, the cloud proxy 170 transmits the modified data packets 214 to the server application 180 (the originally intended destination). It will be understood that the source IP address of the modified data packets 214 is now that of the cloud proxy 170 and not the client proxy 140, and the source port is that used for port mapping at the cloud proxy 170 and not the endpoint 110. The operations 314 to 328 are carried out for each data packet captured by the client proxy 140, so that these operations are repeated n time for n data packets captured by the client proxy 140. This is indicated by Loop(n) in FIG. 2a.

FIG. 2b shows a schematic 250 of the processes involved in the communication between a server application 180 and a client endpoint 110 (i.e. server-client communication). Further, a corresponding method 350 used to carry out the communication between the server application 180 and the client endpoint 110 is shown as a flowchart in FIG. 3b.

At operation 330, in response to the data packet sent to the server application 180 at operation 326, the server application 180 forwards a response data packet 216 to the source (i.e. the cloud proxy 170). The payload of the response packet 216 will application specific, and will additionally comprise the packet header, the cloud proxy's 170 IP address and port number (e.g. B:99 in the example given above). The response data packet 216 uses the cloud proxy IP address as a destination IP address. In the illustrated example, the data packet sent from the server application 180 to the client application 130 is a response to a data packet received from the client application 130, and for this reason, and to clarify the direction of travel, is referred to as a response data packet 216. It will be understood that the server application 180 routes all responses through the cloud proxy 170, since all requests sent from the cloud proxy 170 to the server application 180 contain the IP address and port of the cloud proxy 170 as the source of the data packet. The server application 180 uses the cloud proxy IP address for the response data packets 216, and not the IP address of the client endpoint 110 (which is hidden from the server application 180 by the cloud proxy 170).

At operation 332, the cloud proxy 170 maps the IP address and the port number of the response packet 216 (e.g. B:99, see also operation 326) back to the IP address of the client endpoint 110 and the port number 88 associated with the client application 130. (e.g. A:88), and modifies the response packet 216 by replacing its address to that address and the port number (e.g. replaces it B:99 with A:88). In one example, the cloud proxy 170 generates a hash, which maps the port number 99 back to A:88. This ensures that the response packet 216 is forwarded to the correct client proxy 140 by the cloud proxy 170. At operation 334, the cloud proxy 170 encrypts the response packet 216 using the appropriate (i.e. previously agreed with client endpoint 110) symmetric key 208 provided by the symmetric key agreement cloud 190 in a similar manner to the earlier operations. The symmetric key 208 may be the same symmetric key used for encrypting the data packet 210, or a different one (as long as the symmetric key to be used has been mutually agreed by the endpoint 110 and the application cloud 120). Additionally, in the same operation 336, the cloud proxy 170 prepends a UDP header, and appends a KEYID and IV to each response packet 216 to produce an encapsulated UDP response packet 218 (i.e. {ENCRYPTEDTCPPACKET, KEY ID, IV}). In some examples the ENCRYPTEDTCPPACKET, KEY ID, and IV can be in any order, as along as the UDP header is at the start. At operation 336, the cloud proxy 170 forwards the encapsulated UDP packet 218 to client proxy 140.

At operation 338, the client proxy 140 intercepts the encapsulated UDP response packet 218, strips the UDP header, and decrypts (using the appropriate symmetric key 208 previously agreed between the endpoint 110 and the application cloud 120) the UDP packet to release the original server-application response packet 220. For example, the client proxy 140 will receive the packet on e.g. 79.115.55.32:9080, the packet is stripped, and then decrypted which gives the original packet that refers to 79.115.55.32:<original client port>. Finally, at operation 340, the client proxy 140 forwards the response packet 220 to the appropriate client application 130, thus completing the server-client communication process. As with client-server communication, server-client communication process (operations 330 to 340) are repeated n times for n data packets captured by the cloud proxy 170. This is indicated by Loop(n) in FIG. 2b.

In the illustrated example the server-client communication schematic 250 of FIG. 2b and method 350 of FIG. 3b are described for a situation where the symmetric keys 208 have already been received by the client proxy 140 and cloud proxy 170 from the symmetric key agreement cloud 190.

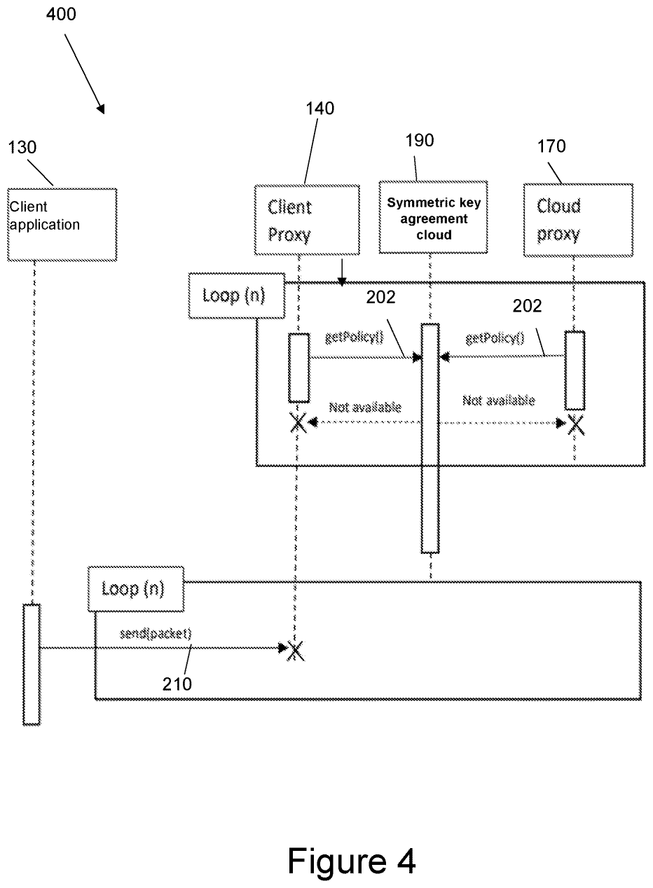

FIG. 4 illustrates a schematic 400 of the system 100 in a situation when the symmetric key agreement cloud 190, cloud proxy 170 or the destination is in the downed (for example, inoperative, or offline) state during the client-server communication process. When the symmetric key agreement cloud 190 is in the downed state, the client proxy 140 or the cloud proxy 170 will try requesting the security policy again after a set amount of time. If the request is successful, the process will continue as illustrated in FIGS. 2 and 3b. Otherwise, the client proxy 140 or the cloud proxy 170 will report an error and exit. The client proxy 140 is still intercepting traffic, however, the data packets 210 will not be forwarded to the cloud proxy 170. When the cloud proxy 170 is not available (not shown in figure), the data packet will not be receivable by the cloud proxy 170 (as this is not available), and so will not be decrypted and forwarded to the server application 180. This situation will appear to the client application 130 as a normal Transmission Control Protocol (TCP) packet drop. This is because the TCP stack in the client application 130 will never receive a response and will fail with a connection error/connection drop. If a resend attempt is successful, the process will continue as usual (i.e. from operation 320 in FIG. 3a). Otherwise, the data packet 210 will not be received by the cloud proxy 140. It will be understood that the system will not allow data packets to be sent if any part of the system is not working, as this could potentially allow an adversary to force the system to stop protecting traffic by manipulating the environment.

The present disclosure provides the advantage that the installation and management of the system 100 is made easy by the installable endpoint proxies 140 and 170, and a security policy 204 configured in the symmetric key agreement cloud 190. Additionally, the system 100 is transparent to the user as data packets are routed transparently through the proxies 140 and 170. The system 100 also does not interfere with TLS, because by routing all TLS packets unmodified through a dedicated tunnel, TLS termination points are unchanged, meaning that there is no traditional man-in-the-middle proxy which is able to inspect the plaintext traffic. Moreover, TLS key agreement messages are hidden inside the encrypted packets meaning that the analysis phase of the attack will not be able to identify the traffic via plaintext TLS handshakes, and so anonymises the TLS traffic.

The systems 100 provide several advantages. Firstly, all traffic to and from specified applications through a communications network (195) where the keys are negotiated between the proxies 140 and 170 using QuantumCloud™ or other cloud service. This means that traffic to and from the applications 130 and 180 is protected from SNDL (store-now, decrypt later) attacks as the data flows over the communications network 195. Secondly, TLS connections are not broken by the system 100, such that the certificate being used on the client is the application certificate and not that of an authorised man-in-the-middle (i.e. TLS termination points should be unchanged by this solution). The TLS connection starts at the client application 130 and finishes at the cloud application 120, and it runs through the proxies 140 and 170 and through the communications network 195. The TLS connection is not broken by the system 100 because it is negotiated using Diffie-Hellman key exchange via a series of handshakes that initialise the connection. Since these handshakes are just packets of data, it is possible to route and encrypt the handshakes through the proxies 140 and 170 without any issues. This means that the TLS connection is established between the client application 130 and the application cloud 120 even though the handshakes are “wrapped” by proxies 140 and 170 (but without changing the handshakes).

In the embodiments described above, the server may comprise a single server or network of servers. In some examples, the functionality of the server may be provided by a network of servers distributed across a geographical area, such as a worldwide distributed network of servers, and a user may be connected to an appropriate one of the network servers based upon, for example, a user location.

The above description discusses embodiments of the invention with reference to a single user for clarity. It will be understood that in practice the system may be shared by a plurality of users, and possibly by a very large number of users simultaneously.

The embodiments described above are fully automatic. In some examples a user or operator of the system may manually instruct some steps of the method to be carried out.

In the described embodiments of the invention the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and Blu-ray (RTM) disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fibre optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAS), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible.

Accordingly, the described aspects are intended to embrace all such alterations, modifications, and variations that fall within the scope of the appended claims.

1-32. (canceled)

33. A method for communication between a client endpoint and an application cloud across a communications network, the method comprising:
i) negotiating, between a client proxy and a cloud proxy, one or more common symmetric keys using a symmetric key agreement system, wherein the client proxy is located within the client endpoint, and the cloud proxy is located within a security perimeter of the application cloud;
ii) capturing, by the client proxy, a data packet from a client application, wherein an IP address, subnet or domain to which the data packet is being sent is defined in a security policy, and wherein the client application is located within the same client endpoint as the client proxy;
iii) encrypting, by the client proxy, the captured data packet using a common symmetric key, to form an encrypted data packet;
iv) forwarding, by the client proxy, the encrypted data packet to the cloud proxy, wherein the security policy specifies the IP address of the cloud proxy to which the data packet is to be forwarded;
v) decrypting, by the cloud proxy, the encrypted data packet using the common symmetric key to obtain the captured data packet;
vi) modifying, by the cloud proxy, the data packet by replacing an IP address associated with the client endpoint and a port number associated with the client application with an IP address and a port number associated with the cloud proxy; and
vii) forwarding, by the cloud proxy, the decrypted data packet to the server application, wherein the server application corresponds to a destination IP address specified in the data packet, and wherein the server application is located within the same security perimeter as the cloud proxy.

34. The method of claim 33, wherein operations ii) to vii) are repeated for each data packet captured by the client proxy.

35. The method of claim 33, wherein the method further comprises obtaining, by a client proxy, the security policy from the symmetric key agreement system prior to capturing the data packet by the client proxy.

36. The method of claim 35, wherein the obtaining the security policy comprises requesting, by the client proxy, the security policy from the symmetric key agreement system, and in the event that client proxy is not successful in receiving the security policy, the client proxy sends a further request after a set amount of time to the symmetric key agreement system to obtain the security policy.

37. The method of claim 33, wherein the security policy further specifies one or more cloud proxy IP addresses corresponding to one or more cloud proxies to be routed through the security policy, wherein each cloud proxy is located in a different application cloud.

38. The method of claim 33, wherein the client proxy encapsulates each encrypted data packet with a user datagram protocol (UDP) header prior to transmitting each data packet to the cloud proxy.

39. The method of claim 38, wherein the client proxy sets a maximum transmission unit of a network interface prior to encapsulation, wherein the client endpoint comprises the network interface, and wherein the network interface is configured to route data packets in and out of the client endpoint.

40. The method of any of claim 33, wherein, after the decrypting, the cloud proxy caches the IP address and the port number associated with the client application for each data packet received from the client proxy.

41. The method of claim 40, wherein the cloud proxy removes the UDP header from each data packet prior to caching the IP address associated with the client endpoint and the port number associated with the client application.

42. The method of claim 41, wherein the cloud proxy modifies each decrypted data packet by replacing the IP address of the client endpoint with a corresponding cloud proxy IP address, and wherein the cloud proxy further maps the port number associated with the client application to an empty port associated with the cloud proxy, prior to transmitting each data packet to the server application.

43. The method of claim 33, wherein the client endpoint is a web gateway.

44. The method of claim 33, wherein the client application is a web gateway application.

45. The method of claim 33, wherein the symmetric key agreement system is a symmetric key cloud.

46. The method of claim 33, wherein the communications network is the Internet.

47. The method of claim 33, wherein, apart than being encrypted and modification of the IP address and port number of the data packets when being forwarded between the client proxy and the cloud proxy, the data packet is otherwise unmodified by the client proxy and the cloud proxy, such that Transport Layer Security, TLS, connections remain unbroken

48. The method of claim 33, wherein if cloud proxy is not available, the data packet is not forwarded to the cloud proxy, and the client application will register this as a Transmission Control Protocol (TCP) packet drop.

49. A method for communication between a client endpoint and an application cloud across a communications network, the method comprising:
i) forwarding, by the server application, the response packet to the cloud proxy, wherein the forwarding of the response packet by the server application is in response to a data packet sent by the cloud proxy;
ii) modifying, by the cloud proxy, the response packet by replacing an IP address and port number associated with the cloud proxy with an IP address associated with the client endpoint and port number associated with a client application, wherein the client application is located within the client endpoint;
iii) encrypting, by the cloud proxy, the response packet using a common symmetric key, to form an encrypted response packet, wherein the common symmetric key has been negotiated between a client proxy and the cloud proxy;
iv) forwarding, by the cloud proxy, the encrypted response packet to the client proxy, wherein the client proxy is located within the client endpoint, and wherein the client application is located within the same client endpoint as the client proxy;
v) decrypting, by the client proxy, the encrypted response packet using said common symmetric key; and
vi) forwarding, by the client proxy, the decrypted response packet to the client application.

50. The method of claim 49, wherein operations i) to vi) are repeated for each response packet forwarded by the server application.

51. The method of claim 49, wherein the cloud proxy encapsulates each encrypted response packet with a user datagram protocol header prior to transmitting the encrypted response packet to the client proxy.

52. A method of communication by a client endpoint with an application cloud across a communications network, the method comprising:
i) negotiating, by a client proxy with a cloud proxy, one or more common symmetric keys using a symmetric key agreement system, wherein the client proxy is located within the client endpoint, and the cloud proxy is located within the application cloud;
ii) capturing, by the client proxy, a data packet from a client application, wherein an IP address, subnet or domain to which the data packet is being sent is defined in a security policy, and wherein the client application is located within the same client endpoint as the client proxy;
iii) encrypting, by the client proxy, the captured data packet using a common symmetric key, to form an encrypted data packet; and
iv) forwarding, by the client proxy, the encrypted data packet to the cloud proxy, wherein the security policy specifies the IP address of the cloud proxy to which the data packet is to be forwarded, whereby the cloud proxy is able to decrypt the encrypted data packet using the common symmetric key.
